(19) United States
(12) Patent Application Publication
(10) Pub. No.: US 2023/0215599 A1
(43) Pub. Date: Jul. 6, 2023

(54) BI-WIRE AUDIO SYSTEM

(71) Applicant: Belden Inc., St. Louis, MO (US)

(72) Inventor: Galen Gareis, Oxford, OH (US)

(21) Appl. No.: 18/090,276

(22) Filed: Dec. 28, 2022

Related U.S. Application Data
(60) Provisional application No. 63/295,082, filed on Dec. 30, 2021.

(51) Int. Cl. H01B 11/00; H01B 7/00

(52) U.S. Cl. CPC H01B 11/00; H01B 7/0054; H01B 13/00

(57) ABSTRACT

A bi-wire audio cable system designed to reduce propagation velocity (Vₚ) differentials between low and high frequencies within the audio band, by adjusting the resistive and capacitive components of the cables. By utilizing two cables, one for low frequencies and one for high frequencies, with different characteristics, the impedance of the cables can be configured to be relatively consistent across the audio spectrum, minimizing the change in Vₚ, thereby increasing audio fidelity. The bi-wire audio system can include a first (e.g. high frequency) cable with a first plurality of insulated conductors having a first conductor gauge; and a second (e.g. low frequency) cable with a second plurality of insulated conductors having a second, larger conductor gauge. The cables can be connected together at an output of an amplifier, and can be connected to corresponding low and high frequency inputs of a speaker (e.g. a woofer and tweeter).

### CROSS-REFERENCE TO RELATED PATENT APPLICATIONS

This application claims the benefit of and priority to U.S. Provisional Patent Application No. 63/295,082 filed Dec. 30, 2021, the entirety of which is incorporated by reference herein.

### BACKGROUND

Speaker cable systems can include wires.

### SUMMARY

The present disclosure describes apparatuses and methods of a bi-wire audio cable system that can reduce propagation velocity differentials between low and high frequencies within the audio band, by adjusting the resistive and capacitive components of the cables. Implementations of the bi-wire audio system can utilize two cables, one for low frequencies and one for high frequencies, with different characteristics, the impedance of the cables can be configured to be relatively consistent across the audio spectrum, minimizing the change in Vp and reducing group delay, thereby increasing audio fidelity.

At least one aspect is directed to a bi-wire audio system. The bi-wire audio system can include a first cable. The first cable can have a first plurality of insulated conductors. Each conductor can have a first diameter. The first cable can be connected to a high frequency input of a speaker. The bi-wire audio system can also include a second cable. The second cable can have a second plurality of insulated conductors. Each conductor can have a second diameter. The second cable can be connected to a low frequency input of the speaker. The second diameter of each conductor of the second plurality of insulated conductors can be larger than the first diameter of each conductor of the first plurality of insulated conductors.

At least one aspect is directed to a system. The system can include a first plurality of insulated conductors. Each conductor can have a first diameter. The first plurality of insulated conductors can be connected to a high frequency input of a speaker. The system can also include a second plurality of insulated conductors. Each conductor can have a second diameter. The second plurality of insulated conductors can be connected to a low frequency input of the speaker. The second diameter of each conductor of the second plurality of insulated conductors can be larger than the first diameter of each conductor of the first plurality of insulated conductors.

At least one aspect is generally directed to a method of manufacturing a bi-wire audio cable. The method can include disposing, within a first cable, a first plurality of insulated conductors. Each conductor can have a first diameter. The first cable can be connected to a high frequency input of a speaker. The method can also include disposing, within a second cable, a second plurality of insulated conductors. Each conductor can have a second diameter. The second cable can be connected to a low frequency input of the speaker. The second diameter of each conductor of the second plurality of insulated conductors can be larger than the first diameter of each conductor of the first plurality of insulated conductors.

At least one aspect is generally directed to a method of providing a bi-wire audio cable. The bi-wire audio cable can include a first cable. The first cable can have a first plurality of insulated conductors. Each conductor can have a first diameter. The first cable can be connected to a high frequency input of a speaker. The bi-wire cable can also include a second cable. The second cable can have a second plurality of insulated conductors. Each conductor can have a second diameter. The second cable can be connected to a low frequency input of the speaker. The second diameter of each conductor of the second plurality of insulated conductors can be larger than the first diameter of each conductor of the first plurality of insulated conductors.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1A is a block diagram of single-wiring of a two-way speaker;

FIG. 1B is a block diagram of bi-wiring of a two-way speaker;

FIG. 1C is a graph of propagation velocity vs. frequency of conductors with different capacitance;

FIG. 1D is a graph of propagation velocity vs. frequency of conductors with different resistances due to different diameters or gauge sizes;

FIG. 1E is a graph of propagation velocity vs. frequency of a bi-wire cable system;

FIG. 2 is an illustration of a segment of a bi-wire cable system;

FIG. 3A is a diagram of a braid of three bonded pairs of conductors to form a subset for a cable of a bi-wire cable system;

FIG. 3B is a diagram of a braid of three subsets of FIG. 3A for a cable of a bi-wire cable system;

FIG. 3C is a diagram of two signal polarity carrying legs of FIG. 3B for a cable of a bi-wire cable system;

FIG. 3D is a diagram of a cable of a bi-wire cable system including two signal polarity carrying legs of FIG. 3C and a covering;

FIG. 3E is a diagram of a cross-section of the shielded cable of a bi-wire cable system of FIG. 3D;

FIG. 4 is a block diagram of a parallel bi-wiring of a two way speaker;

FIG. 5 is a graph of swept impedance vs. frequency of cables having different characteristics;

FIG. 6 is a graph of swept impedance vs. frequency of a parallel bi-wiring of cables having different characteristics;

FIG. 7 is a graph of propagation velocity vs frequency of cables having different characteristics;

FIG. 8 is a graph of swept resistance vs frequency of cables having different characteristics;

FIG. 9 is a graph of swept resistance vs frequency of a parallel bi-wiring of cables having different characteristics;

FIG. 10 is a diagram of a process of manufacturing a bi-wire audio cable; and

FIG. 11 is a diagram of a process of providing a bi-wire audio cable.

### DETAILED DESCRIPTION

The present disclosure describes a bi-wire audio cable system. The bi-wire audio system can include a first (e.g. high frequency) cable with a first plurality of insulated conductors having a first conductor gauge (e.g. 28 AWG, though other sizes can be utilized); and a second (e.g. low frequency) cable with a second plurality of insulated conductors having a second, larger conductor gauge (e.g. 24 AWG, though other sizes can be utilized). The characteristics of at least one the first cable and the second cable can be different from above. For example, the characteristics of the first cable and the second cable can be switched with one another.

The cables can be connected together at an output of an amplifier, and can be connected to corresponding low and high frequency inputs of a 2-way speaker (e.g. a woofer and tweeter). The low frequencies can refer to audio frequencies less than approximately 200 Hz. The low frequencies carried by the cable can extend higher, such as 400 Hz, 800 Hz, or 1 kHz or higher, while high frequencies can refer to audio frequencies above this value. Crossover filter networks within the speaker (used to separate out low frequencies for the woofer and high frequencies for the tweeter) can filter the corresponding signals, allowing the cables' different characteristics to correspondingly affect the low and high frequency audio such that the propagation velocity differential is minimized.

Signals can propagate at different velocities in cables at frequencies across the audio band (i.e. between roughly 20 Hz to 20 kHz), with propagation velocity (Vp) varying significantly between high frequency and low frequency signals. For example, given a typical zipcord speaker cable, Vp can vary from −110,000,000 m/sec at 20 kHz to −5,000,000 m/sec at 20 Hz, or a factor of 22 times slower across the audio band. The difference in time for signals at different frequencies to propagate down the cable is sometimes referred to as group delay and can result in loss of fidelity.

Audio signals can be in a range from approximately 20 Hz to approximately 20 kHz, representing four orders of magnitude. Cables can have constant Vp at RF, resulting in the impedance being flat at RF. The Vp can change below RF down to direct current (DC), and the change in Vp can impact the impedance. For example, the impedance can go up as the frequency drops. The Vp changes can also impact how signals arrive in the time domain, and how the signals interact with the load impedance at the cable end.

The capacitance values, and the inductance values of a cable can be changed based on the material used in the cable and/or the distance from one wire to another wire. For example, the capacitance of the cable can be adjusted using materials with different characteristics. Similarly, the distance between and/or from another wire can adjust the capacitance and/or the inductance of the cable. The values of capacitance, and inductance along with the change in Vp, across the audio band, can impact and/or vary the sound and/or signal of the cable.

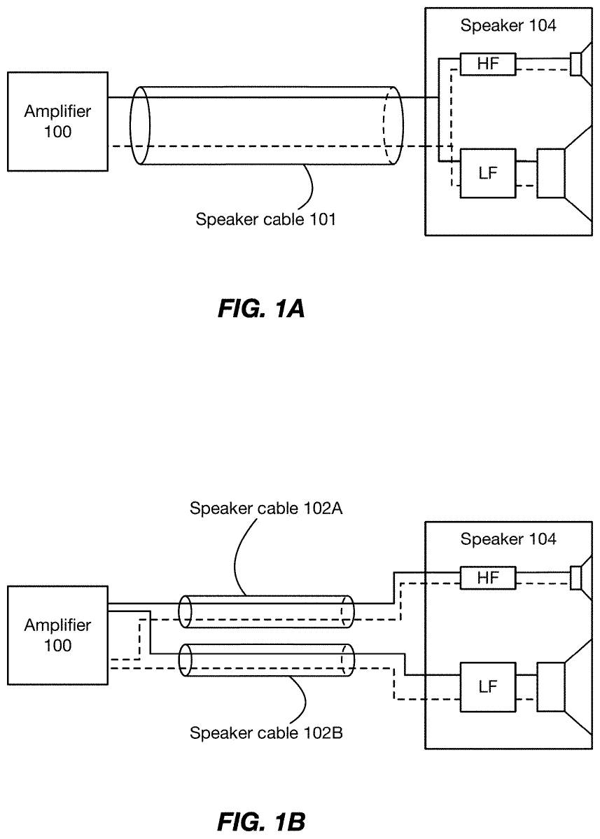

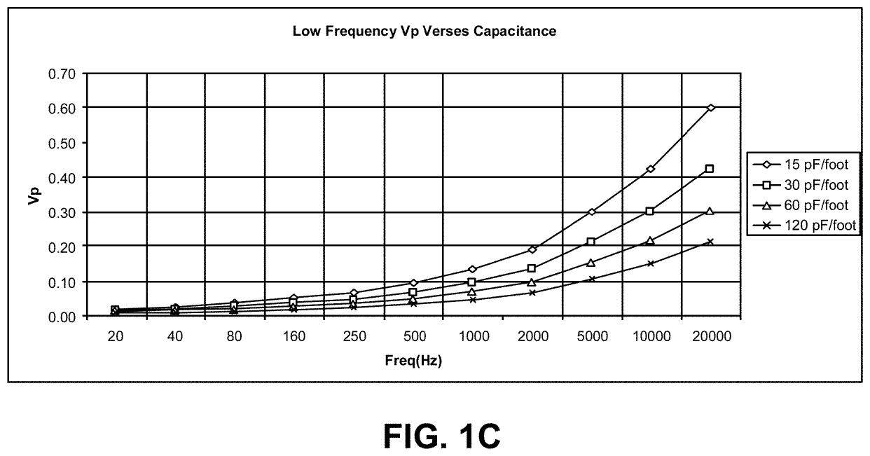

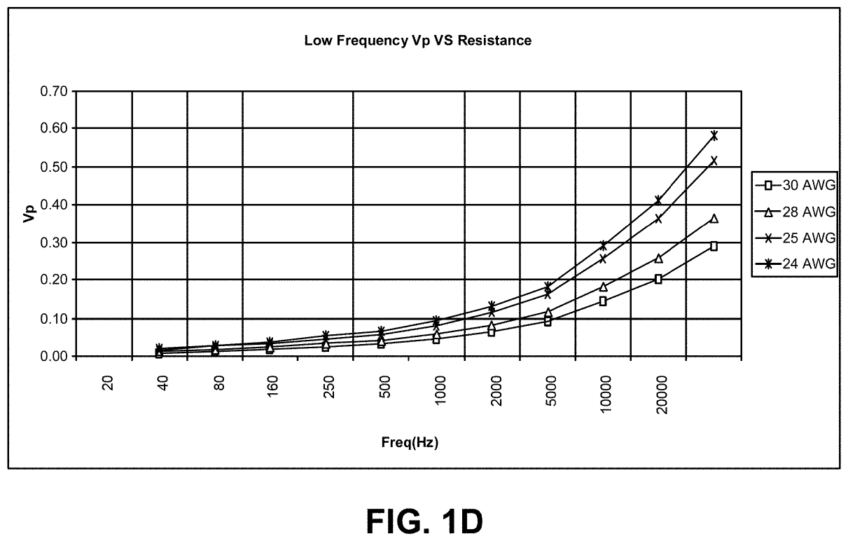

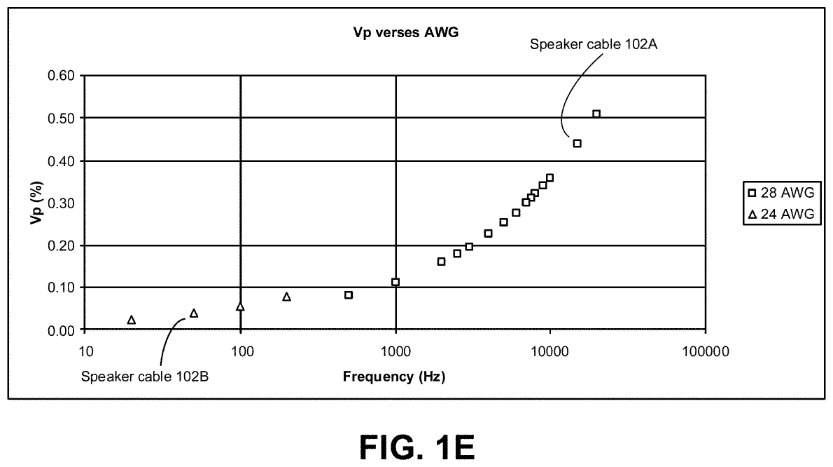

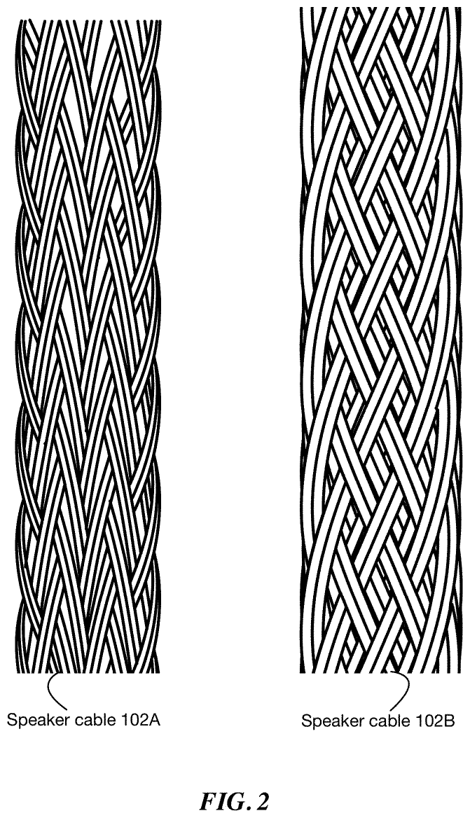

FIG. 1A, is an illustration of a block diagram of a single-wiring of a two-way speaker. As shown, a signal source, such as an amplifier 100, can be connected via a speaker cable 101 to a two-way speaker 104 including a low frequency driver or woofer, a high frequency driver or tweeter, and corresponding low frequency and high frequency filters of a two-way crossover network (e.g. typically low pass and high pass filters with breakpoints with corresponding frequencies, e.g. approximately 200 Hz, 400 Hz, 1 kHz, 2 kHz, or any other such frequency, depending on design). Although shown as a two-way speaker, the speaker can be a three-way speaker (e.g. with a separate mid-range driver and a corresponding band-pass filter). The cable 101 is shown with two polarity conductors or legs (one in solid line and one in dashed line). The single cable 101 can be connected to corresponding inputs of the crossover network (which can be bridged internally or externally, such as via jumpers between input terminals on the speaker). As discussed above, audio signals transmitted via the cable can propagate at different velocities based on frequency, and this temporal distortion can be audible, particularly for longer cables (such as those used in large theaters). For example, a snare drum having both low frequency and high frequency components played through such a system can have the low frequency components arriving several milliseconds later than high frequency components, resulting in a smeared or non-coherent sound, reducing reproductive fidelity relative to the source. Bi-wiring can separate the speakers and filter networks with two cables at the output of the amplifier.

FIG. 1B is an illustration of a block diagram of a bi-wiring of a two-way speaker 104. Two speaker cables 102A, 102B are connected to the outputs of the amplifier 100 (with each corresponding leg or polarity connected to the same or connected output terminals, as shown) and separately connected to the inputs of the low and high frequency filters of the speaker (with any internal or external jumper removed or disabled). If the two cables 102A, 102B are identical, the same propagation velocity differential will result; however, these cables can be different, and selection of different impedance characteristics can allow for adjustment of the propagation velocity in each cable to reduce the differential. For example, the characteristics of the high frequency cable 102A can be selected to reduce high frequency signal propagation velocities to more closely match the low frequency signal propagation velocities of the low frequency cable 102B, thereby improving signal coherence and reducing the group delay or differential to sub-audible levels.

At low frequencies the propagation velocity can be approximated as Vp=sqrt(2ω/RC), with ω=2π*frequency(Hz); while at higher frequencies, the propagation velocity can be approximated as Vp=1/(sqrt(LC)). At high frequencies, the Vp can also be approximated as Vp=1/SQRT(e), where e=dielectric constant. By utilizing two cables, one for low frequencies and one for high frequencies, with different characteristics, the cables can be configured to decrease the rise in impedance at lower frequencies. For example, the Vp can be altered, based on Resistance, and Capacitance characteristics of the cable, for high frequencies, and the change in Vp for high frequencies can decrease the rise in impedance at lower frequencies.

FIG. 1C is a graph of propagation velocity vs. frequency for conductors with different capacitance (e.g. 15 pF/foot, 30 pF/foot, 60 pF/foot, and 120 pF/foot), with Vp shown as a factor of the speed of light c (e.g. Vp=0.5=0.5c or 1.499*10\hat{ }8 meters per second), and listed in table 1 below:

TABLE 1
Vₚ vs. Capacitance

| Frequency | | 15 pF/foot | 30 pF/foot | 60 pF/foot | 120 pF/foot |
|---|---|---|---|---|---|
| 20 | Hz | 0.02 | 0.01 | 0.01 | 0.01 |
| 40 | Hz | 0.03 | 0.02 | 0.01 | 0.01 |
| 80 | Hz | 0.04 | 0.03 | 0.02 | 0.01 |
| 160 | Hz | 0.05 | 0.04 | 0.03 | 0.02 |
| 250 | Hz | 0.07 | 0.05 | 0.03 | 0.02 |
| 500 | Hz | 0.09 | 0.07 | 0.05 | 0.03 |
| 1000 | Hz | 0.13 | 0.09 | 0.07 | 0.05 |
| 2000 | Hz | 0.19 | 0.13 | 0.09 | 0.07 |
| 5000 | Hz | 0.30 | 0.21 | 0.15 | 0.11 |
| 10000 | Hz | 0.42 | 0.30 | 0.21 | 0.15 |
| 20000 | Hz | 0.60 | 0.42 | 0.30 | 0.21 |

As shown, while the propagation velocity increases for each conductor as the frequency of the signal increases, higher capacitances reduce this effect at high frequencies (with less of an effect at low frequencies).

FIG. 1D is a graph of propagation velocity vs. frequency for conductors with different resistances (e.g. due to different diameters or gauge sizes, with conductors of 24 AWG, 25 AWG, 28 AWG, and 30 AWG illustrated), listed in table 2 below:

TABLE 2
Vₚ vs. Resistance

| Frequency | | 30 AWG | 28 AWG | 25 AWG | 24 AWG |
|---|---|---|---|---|---|
| 20 | Hz | 0.01 | 0.01 | 0.02 | 0.02 |
| 40 | Hz | 0.01 | 0.02 | 0.02 | 0.03 |
| 80 | Hz | 0.02 | 0.02 | 0.03 | 0.04 |
| 160 | Hz | 0.03 | 0.03 | 0.05 | 0.05 |
| 250 | Hz | 0.03 | 0.04 | 0.06 | 0.06 |
| 500 | Hz | 0.05 | 0.06 | 0.08 | 0.09 |
| 1000 | Hz | 0.06 | 0.08 | 0.12 | 0.13 |
| 2000 | Hz | 0.09 | 0.12 | 0.16 | 0.18 |
| 5000 | Hz | 0.14 | 0.18 | 0.26 | 0.29 |
| 10000 | Hz | 0.20 | 0.26 | 0.37 | 0.41 |
| 20000 | Hz | 0.29 | 0.37 | 0.52 | 0.58 |

As shown, higher resistances (from smaller conductors) result in lower propagation velocities at high frequencies, with less of an effect at low frequencies. As discussed above, the capacitance and resistance both affect propagation velocity, with Vp, at low frequency approximately,=Sqrt(2ω/(R*C)).

Accordingly, a higher resistance cable can be used for higher frequencies in a bi-wire cable system to reduce propagation velocity for high frequencies, while using a lower resistance cable for lower frequencies. Each wire can have a certain resistance value, and a certain number of wires can be placed in parallel resulting in the cable having a predetermined resistance value. For example, the predetermined resistance value, for the cable, can be 10 ohms, and a first wire can have a resistance of 20 ohms, and a second wire can also have a resistance value of 20 ohms. The first wire, and the second wire can be placed in parallel, within the cable, resulting in the resistance of the cabling equaling 10 ohms. The resistance of the cable can be equal to the product of each wires resistances divided by the sum of each wires resistance. For example, the resistance of a cable with two wires can be equal to (resistance of first wire*resistance of second wire)/(resistance of first wire+resistance of second wire).

FIG. 1E is a graph of propagation velocity vs. frequency for a bi-wire cable system, with a low frequency cable 102B used for frequencies below 200 Hz, and a high frequency cable 102A used for frequencies above 200 Hz. For example, the high frequency cable 102A can be used for frequencies higher than and/or equal to 300 Hz. In the example illustrated, the high frequency cable uses individually insulated 28 AWG conductors resulting in higher resistance and corresponding lower propagation velocities at high frequencies, while the low frequency cable uses individually insulated 24 AWG conductors. The characteristics used in the high frequency cables 102A can be chosen to increase and/or improve performance at high frequencies without considering the performance of the high frequency cables 102A at low frequencies as the low frequency cables 102B can be used in the low frequencies. Similarly, the characteristics used in the low frequency cables 102B can be chosen to increase and/or improve performance at low frequency without considering the performance of the low frequency cables 102B at high frequencies at the high frequency cables 102A can be used in the high frequencies. The bi-wire cable system, including the high frequency cable 102A, and the low frequency cable 102B, can lower the Vp across higher frequencies by adjusting the Resistance and Capacitance values (in the high frequency cable 102A) to improve performance of the system across the audio band. The impedance values, of the high frequency cable 102A, and the low frequency cable 102B, can converge as the Vp value for the high frequency cable 102A, and the low frequency cable 10B are very similar to one another.

While the combined curves still show a range of propagation velocities, the difference between 20 Hz and 20 kHz in the illustrated example is a factor of approximately 10:1, half that measured using a single cable. Although shown with 24 and 28 AWG conductors, other sizes can be used (e.g. 20 AWG and 26 AWG, 20 AWG and 28 AWG, or any other such combination with varying propagation velocity curves). Each cable can be constructed from braids of bonded pairs of insulated conductors, and can include a plurality of conductors for each signal polarity or leg.

FIG. 2 is an illustration of a segment of a bi-wire cable system. For comparison purposes, the segment illustrated is in the middle of the length of cable. Termination of each cable is discussed in more detail below.

The bonded pairs can be twisted or untwisted. Each braid can include a single braid (e.g. a 3-strand braid of three bonded pairs of conductors, a 6-strand braid of six bonded pairs of conductors, or any other such number), sometimes referred to as a round braid. For example, cable 102A can include two legs, each including 12-strand braid of bonded pairs of insulated conductors, resulting in 24 conductors per signal leg or 48 conductors total. For 28 AWG conductors, this is equivalent to 7632 circular mil area (CMA), with a resistance of 1.36 Ohms/meter (roughly equivalent to an 11 AWG copper conductor). The BULK cable can have a capacitance of 65 pF/foot and an inductance of 0.080 μH/foot. Conversely, cable 102B can include two legs, each including a 6-strand braid of bonded pairs of insulated conductors, resulting in 12 conductors per signal leg or 24 conductors total. For 24 AWG conductors, this is equivalent to 9600 CMA, or approximately 1.0 Ohms/meter resistance (roughly equivalent to a 10 AWG copper conductor). BULK Cable 102B can have a capacitance of 50 pF/foot and an inductance of 0.080 pH/foot. Propagation velocity for the cable illustrated in FIG. 2 was tested across the audio band, resulting in the measurements shown in FIG. 1E and listed below in table 3:

TABLE 3
Vₚ per Frequency

| Frequency | Cable 102A | Cable 102B |
|---|---|---|
| (Hz) | (28 AWG) | (24 AWG) |
| 20 | 0.02 | 0.02 |
| 50 | 0.03 | 0.04 |
| 100 | 0.04 | 0.05 |
| 200 | 0.05 | 0.08 |
| 500 | 0.08 | 0.12 |
| 1000 | 0.11 | 0.17 |
| 2000 | 0.16 | 0.24 |
| 2500 | 0.18 | 0.27 |
| 3000 | 0.20 | 0.30 |
| 4000 | 0.23 | 0.35 |
| 5000 | 0.25 | 0.39 |
| 6000 | 0.28 | 0.42 |
| 7000 | 0.30 | 0.46 |
| 7500 | 0.31 | 0.47 |
| 8000 | 0.32 | 0.49 |
| 9000 | 0.34 | 0.52 |
| 10000 | 0.36 | 0.55 |
| 15000 | 0.44 | 0.67 |
| 20000 | 0.51 | 0.77 |

As shown, utilization of cable 102A for high frequencies starting at a crossover point between 300 Hz to 1 kHz (depending on speaker design) results in a significant reduction in Vₚ at higher frequencies in the audio band relative to cable 102B, and the use of both cables in a bi-wire system results in a reduced differential across the audio band.

The plurality of insulated conductors for each signal leg or polarity act in parallel to reduce overall resistance for the signal, and can be of a relatively high gauge or narrow diameter to utilize the entire skin depth of each conductor and avoid skin effect losses at higher frequencies. The conductors for each signal can be braided such that each conductor crosses others at an angle, which can approach or equal 90 degrees. Because the induced current in a wire due to a magnetic field is proportional to the cosine of the angle between the field direction and wire, as this angle approaches 90 degrees due to the geometry of the braid, the induced current in each conductor approaches 0. Additionally, magnetic fields due to current flow in each pair of conductors can be in opposing directions at positions around the intersection of the conductors and cancel, reducing the net magnetic field. Each conductor can be insulated with a material having a high breakdown voltage, such as fluorinated ethylene propylene (FEP), polytetrafluoroethylene (PTFE) (such as TEFLON®, manufactured by E.I. du Pont de Nemours and Company (DuPont) of Wilmington, Del.), allowing very thin insulating walls, decreasing the distance between each conductor in the braid, thereby reducing inductance. Similarly, the insulating material can have a low dielectric constant, thereby reducing capacitance. The weave can also increase the average distance between polarity wires, keeping the capacitance low.

Each leg or polarity within each cable can be separate and parallel, rather than interwoven or braided together, increasing the distance between the two signal conductors, thereby reducing capacitance. Furthermore, because individual conductors within each leg are braided across the diameter of the leg, the average distance between any individual conductor in one leg and any individual conductor in the other leg will be the average distance between the center of each leg. Because the capacitance between the two legs is inversely proportional to their separation, this design can significantly reduce the capacitance of each cable.

Each cable can include a covering and/or shield around both legs, such as one or more of a conductive braid, foil shield, or similar electrostatic interference shielding; an insulating rubber, polyvinyl chloride (PVC), thermoplastic elastomer (TPE) jacket or similar jacket or sheath; and/or nylon or other textile braid, plastic spiral wrap, or similar cover. The covering can provide passive electrostatic interference rejection, as well as structural support to keep the two signal polarity carrying legs together. Similarly, due to the symmetrical and parallel legs, when used for carrying opposite polarities of a signal, external electromagnetic interference can be rejected or canceled. Each cable can be round or substantially round, allowing ease of deployment, superior cable management and durability. The two legs of each cable can be tied or physically held together via textile threads or similar materials woven through gaps between pairs of conductors within each leg. An external covering can be absent.

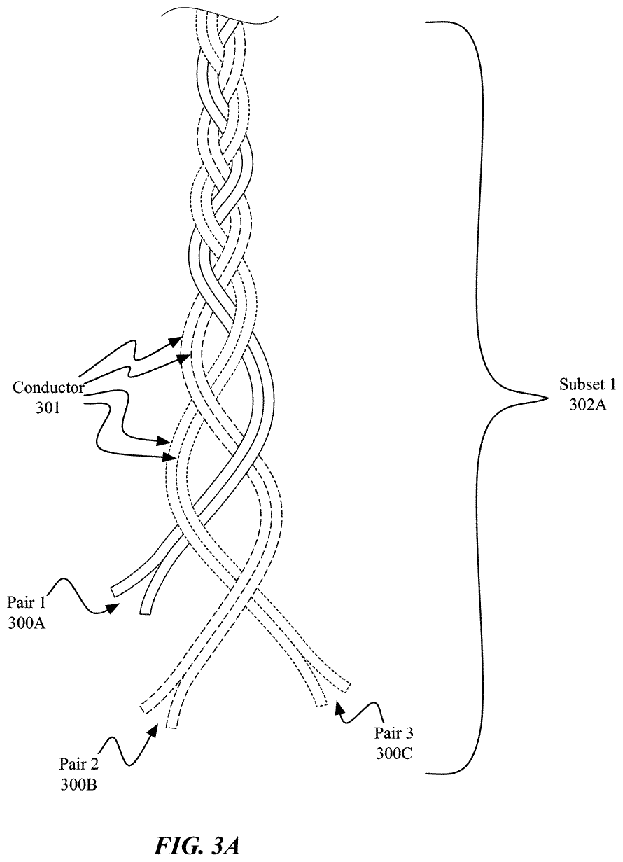

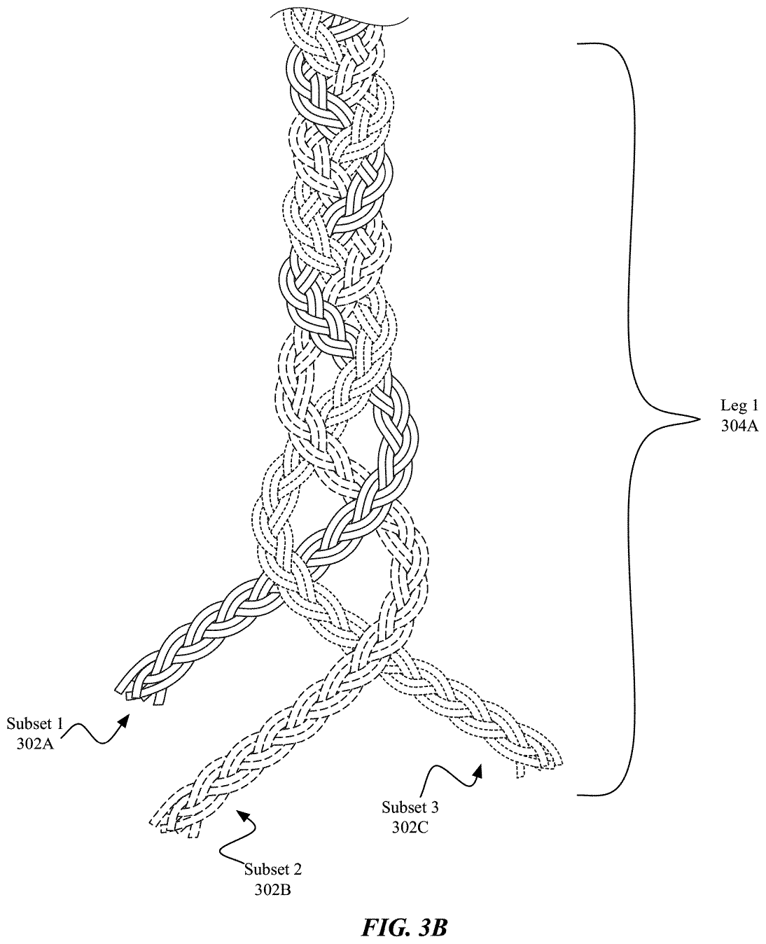

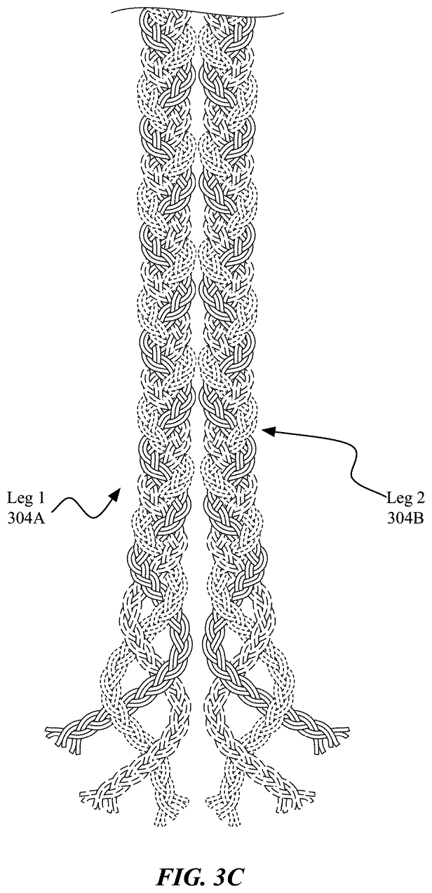

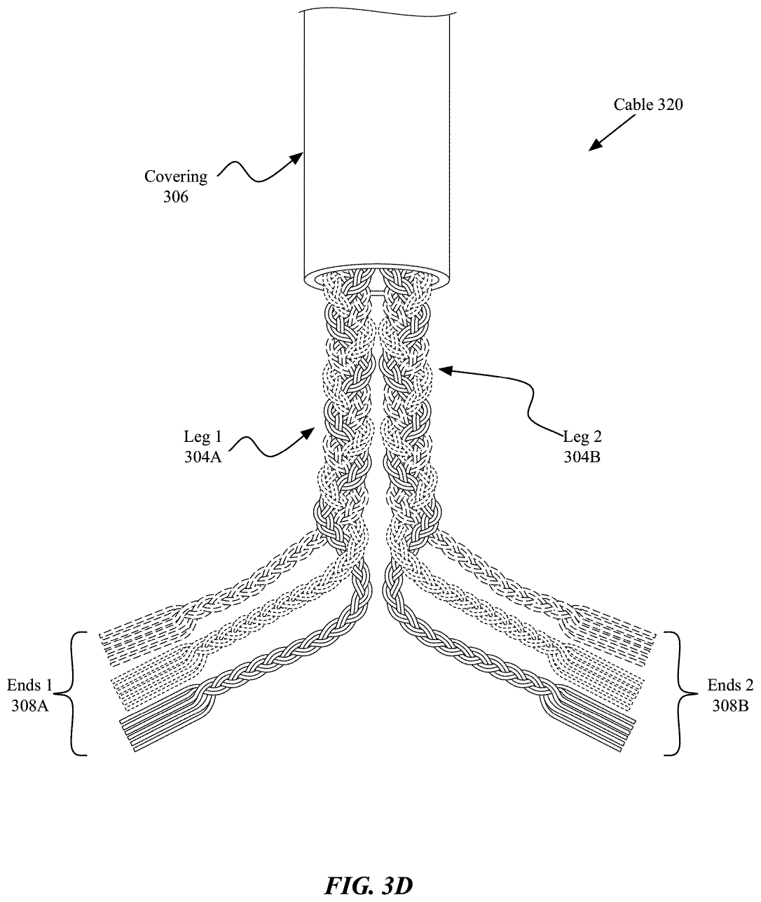

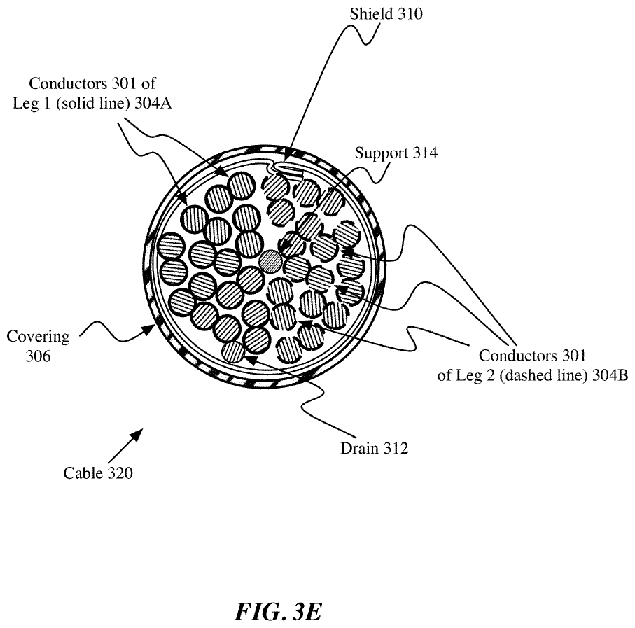

Although shown in FIG. 2 as a round braid (e.g. a single iteration of braiding), each signal leg of the cables can be constructed as a braid of sub-braids (e.g. a braid of three sub 3-strand braids of bonded conductors, resulting in 18 total conductors; a braid of three sub 4-strand braids of bonded conductors, resulting in 24 total conductors, etc.). For example, FIGS. 3A-3E and the accompanying description below describe a braid of sub-braids for cables for a bi-wire cable system. Drawings in FIGS. 3A-3E are not drawn to scale, but can be enlarged to clearly illustrate various features.

Referring first to FIG. 3A, illustrated is a diagram of a braided subset 302A (referred to generally as a subset 302) of three bonded pairs 300A-300C (referred to generally as pair(s) 300) of conductors 301 (referred to generally as conductor(s) 301) for a cable for a bi-wire cable system. Each pair 300 can include a bonded pair of individually insulated conductors, and can be parallel as shown, or can be twisted. Pairs can be unbonded and twisted to minimize spacing between members of the pair. The conductors 301 can be solid or stranded, and can have very small diameters, such as 22, 23, 24, 25 or higher American Wire Gauge (AWG) size (e.g. 0.0253 to 0.0159 inches, or smaller). As discussed above, conductors of a high frequency cable 102A of a bi-wire cable system can have a first diameter, such as 25, 26, 27, 28 or higher AWG size; and conductors of a low frequency cable 102B of a bi-wire cable system can have larger second diameter, such as 22, 23, 24, 25 or higher AWG size. With twisted pairs, the twists of each pair 300 can be of the same or different twist rates, and can be tight or loose (e.g. one complete twist per inch of conductor length, two complete twists per inch, one twist per two inches, etc.). Twisting the pairs can reduce total inductance while increasing total capacitance.

Each conductor 301 can include copper or oxygen-free copper (i.e. having a level of oxygen of 0.001% or less) or any other suitable material, including Ohno Continuous Casting (OCC) copper or silver. Each conductor 301 can be insulated with any type or form of insulation, including polyvinyl chloride (PVC), fluorinated ethylene propylene (FEP) or polytetrafluoroethylene (PTFE) TEFLON®, high density polyethylene (HDPE), low density polyethylene (LDPE), polypropylene (PP), or any other type of insulation. The insulation around each conductor 301 can have a low dielectric constant (e.g. 1-3) relative to air, reducing capacitance between conductors. The insulation can also have a high dielectric strength, such as 400-4000 V/mil, allowing thinner walls to reduce inductance by reducing the distance between the conductors.

As shown in FIG. 3A, each pair 300A-300C can be woven or braided to form a subset 302. Although illustrated with decreasing tightness towards the ends of pairs 300A-300C for clarity, in practice, the subset can be uniformly tight along substantially the entire length of the cable, excepting the terminal portion of each end. The subset can include a simple braid or plait as shown. Although illustrated with three pairs 300A-300C, additional pairs 300 can be added to the subset such as four pairs, five pairs, six pairs, or any other number, and the subset can have any type of regular or complex topology. The overall subset 302 can be flat or substantially flat, round, or have an oval or semi-circular cross section.

As shown in FIG. 3B, a plurality of subsets 302A-302C of FIG. 3A can be woven or braided to form a leg 304A (referred to generally as leg(s) 304) of a cable for a bi-wire cable system. Although illustrated with decreasing tightness towards the ends of subsets 302A-302C for clarity, in practice, the leg can be uniformly tight along substantially the entire length of the cable, excepting the terminal portion of each end. Although illustrated with three subsets 302A-302C, additional subsets 302 can be added to the leg, and the leg can have any type of regular or complex topology. The overall leg can be flat or substantially flat, round, or have an oval or semi-circular cross section. Although illustrated with each subset 302A-302C identical in direction, one or more of subsets 302 can be a reverse or inverse braid. For example, rather than braiding by passing a first pair 300A above a second pair 300B, the first pair can be passed below the second pair. The resulting subset 302 is electrically identical, but physically symmetric to a normal or non-inverse braid. Similarly, subsets 302A-302C can be braided in a normal or inverse fashion to form a leg 304. One or more of subsets 302A-302C can be braided in a first fashion, such as a normal braid, and can be braided in a second fashion, such as an inverse braid, to form a leg 304. Subsets 302A-302C can be formed of three pairs 300 as shown, while leg 304 can be formed of four or more subsets 302, or vice versa, such that the subsets and leg have different and asymmetric topologies. For example, a first cable 102A can include a braid of three subsets of 4-braids of bonded conductors (e.g. 24 conductors per leg), while a second cable 102B can include a braid of three subsets of 3-braids of bonded conductors (e.g. 18 conductors per leg). One cable can include a braid of sub-braids as discussed above, while the other cable can include a simple braid (e.g. a 6-braid of bonded pairs, or 12 conductors per leg).

Each conductor 301 of each pair 300 of a leg 304 can carry the same signal or same polarity of a signal, acting in concert as an equivalent conductor with a much lower gauge, reducing total resistance and signal attenuation. For example, with 18 individual conductors 301 (e.g. three braids of three pairs of conductors) of 0.022 inch diameter, the resulting leg 304 has an equivalent circular mil area (CMA) to an 11.5 AWG cable. The number of iterations and/or number of conductors in each braid can be selected to adjust a total resistance or CMA of the cable.

FIG. 3C is a diagram of two signal carrying legs 304A-304B of FIG. 3B for a cable for a bi-wire cable system. Each leg 304 can carry a single polarity of a signal (sometimes referred to as hot and ground, or positive and negative legs). Because each conductor 301 crosses the entire width of its leg 304, over a long length of cable, the average transverse position of any one conductor 301 is the center of the leg, and the corresponding parasitic capacitance of the cable is approximately equal to a pair of parallel wires with distance d equal to the distance between the centers of each leg. This results in significantly lower capacitance than designs that use interwoven polarities of signals.

Inductance for the cables is also low. Within each leg, current flowing through each conductor 301 generate magnetic fields that roughly cancel each other, due to the close proximity of the conductors within each pair, and because of the geometry of the braid causing conductors to cross at near-perpendicular angles. Furthermore, because the currents through each leg have opposite polarities and the legs are very close to each other relative to the length of the cable, the resulting net magnetic fields of each leg also roughly cancel each other. This reduces overall inductance beyond typical cables with interwoven conductors of each polarity. The legs 304 can be braided symmetrically as shown to further reduce inductance through mutual cancellation of fields.

FIG. 3D illustrates a diagram of a cable 320 for a bi-wire cable system including two signal polarity carrying legs 304A-304B of FIG. 3C and a covering 306. Each leg 304 can be unbraided at a terminal portion such that the individual conductors 301 of each leg are parallel at end portions 308A-308B (referred to generally as end(s) 308). This can allow each conductor 301 to be stripped of insulation at each end 308 and twisted or bonded together for a connector, such as a spade, pin, or banana connector or any other type of connector or plug; or connected to a binding post or similar attachment point. FIG. 3D is drawn with exaggerated lengths of legs 304A-304B extending from covering 306, unbraided lengths of each leg 304, and unbraided lengths of each subset 302 for clarity. In practice, these lengths can be significantly shorter, with covering 306 extending almost to ends 308.

Covering 306 can include any type and form of covering for legs 304 and can provide insulation and/or structural support. For example, covering 306 can include a low-cost spiral plastic or similar covering or split tubular wrap to hold legs 304 together. Covering 306 can include a fabric, Kevlar, polyester, nylon or any other material braid or mesh, providing a strong yet soft and flexible sleeve. Covering 306 can include an insulating sheath or jacket, and can include silicon, rubber, thermoplastic, PVC, Teflon, PE, PP, or any combination of these or other materials. For example, covering 306 can include a plenum-rated jacket of low-smoke PVC, fluorinated ethylene polymer (FEP), PE or other thermoplastic polyolefins, or other such materials. A textile thread or similar material can be woven through gaps between conductors 301 of legs 304A-304B, tying the legs 304 together. Covering 306 can be absent. Covering 306 or threads for binding or tying legs 304 together can be referred to generally as a securing material for securing the two legs in an adjacent configuration. Legs 304 can be held adjacent to each other, in parallel in the same plane or twisted around each other in a helix or otherwise held in close proximity to achieve cancellation of magnetic fields as discussed above.

FIG. 3E is a diagram of a cross-section of the cable 320 of FIG. 3D (not drawn to scale). Individual conductors 301 in pairs 300 of leg 304A are shown in solid line, while individual conductors 301 in pairs 300 of leg 304B are shown in dashed line. The legs 304A-304B can include a semi-circular cross-section as shown, such that the two legs can be placed together to form an approximately circular cross-section cable as shown. This circular or round cross section of cable 320 can provide easier cable management and durability and improved electromagnetic interference (EMI) rejection over flat or ribbon-style cables.

The centroids of each leg 304A-304B are both near the center of the cable, with the result that magnetic fields of conductors of leg 304A and leg 304B are approximately of the same strength and opposite direction due to the opposite polarity of the signal carried by each leg, thus providing additional magnetic field cancellation and reducing the total inductance of the cable. Additionally, because the legs are close, induced currents due to external EMI (sometimes also referred to as radio frequency interference or RFI) are near identical in each leg, cancelling each other within the circuit through common-mode rejection and mostly eliminating such interference.

The cable 320 can include a shield 310, which can include a copper or metallic braid, conductive foil shield, or other type of shield to absorb and discharge to ground external electrostatic charges or interference (ESI, sometimes also considered a subset of EMI). A foil shield or similar shield can be too fragile to solder or otherwise connect to a ground connector, the cable can include a conductive drain wire 312 in contact with shield 310. Drain wire 312 can be any type and form of conductor, including solid or stranded copper or silver or other material, and can be of any diameter. As ESI currents are typically small, drain wire 312 can be of relatively high gauge, such as 16, 18, 20 AWG or any other value. Shield 310 and drain wire 312 can be optional and can be absent.

To provide structural support to the cable, one or more non-conductive supports 314 can be placed within the cable 320 and/or between conductors 301. The supports 314 can include nylon, polyester, cotton, or any other type and form of material, and can be used to provide additional tensile strength to the cable, for example to reduce the strain on conductors 301 when pulling the cable through a wall or conduit. Supports 314 can also provide internal structure to keep conductors 301 from moving within the cable, reducing microphonic noise. One or more supports 314 can be placed around each leg 304 or between conductors 301 of a leg and the shield 310 or covering 306. Supports 314 can be of any size and shape, and can be referred to as cable filler elements. Supports 314 can be optional and can be excluded. As discussed above, supports 314 can also be woven through gaps between conductors 301 of each leg 304 and between each leg 304 to tie the legs together.

Although shown with 18 conductors 301 per leg 304, each leg 304 can include only a single subset 302. Each conductor 301 can have a lower gauge than discussed above, depending on the equivalent CMA required for the cable. Such reduced-conductor cables can be lower in cost to manufacture, while still having low capacitance and inductance. Each conductor 301 can have a high gauge, reducing the overall size of the cable. The cables can be terminated with ¼″ tip-sleeve (TS) or tip-ring-sleeve (TRS) connectors; RCA connectors; XLR connectors; or any other type and form of connector; or can be left unterminated, or pre-stripped and/or tinned for soldering. Additionally, although discussed with two legs carrying opposite polarities of a signal, the cable can include multiple pairs of legs to transmit a number of distinct signals.

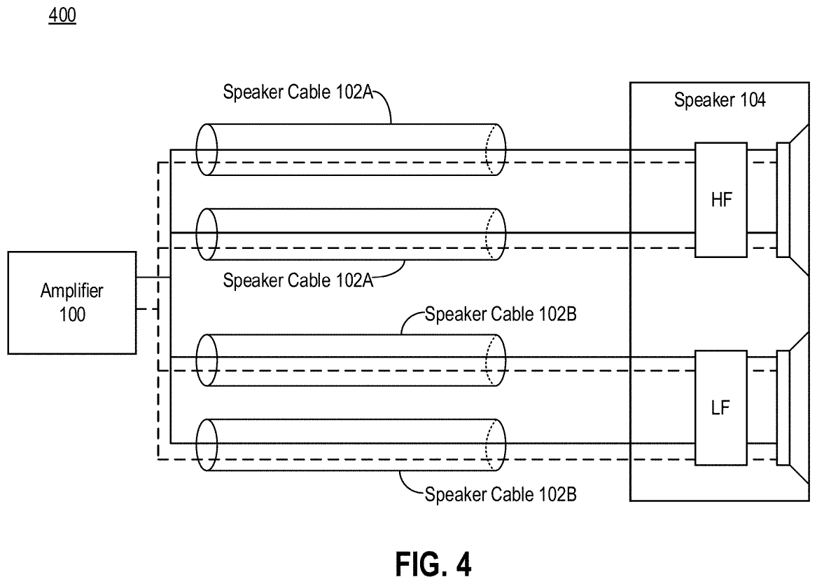

FIG. 4 is a block diagram of a system 400. The system 400 can include the components illustrated in FIG. 1A. The system 400 can include at least first speaker cable 102A, at least one second speaker cable 102A, at least one first speaker cable 102B, at least one second speaker cable 102B, the amplifier 100, and the speaker 104. At least one of the first speaker cable 102A and/or the second speaker cable 102A can be a high frequency cable. At least one of the first speaker cable 102B and/or the second speaker cable 102B can be a low frequency cable. For example, the first speaker cable 102A can be a high frequency cable and the first speaker cable 102B can be a low frequency cable. The first speaker cable 102A can have a propagation velocity that is lower, in relation to the propagation velocity of the first speaker cable 102B, at frequencies within the high frequency ranges. Additionally, the first speaker cable 102A can have a propagation velocity that is similar, in relation to the propagation velocity of the first speaker cable 102B, at frequencies within the low frequency ranges.

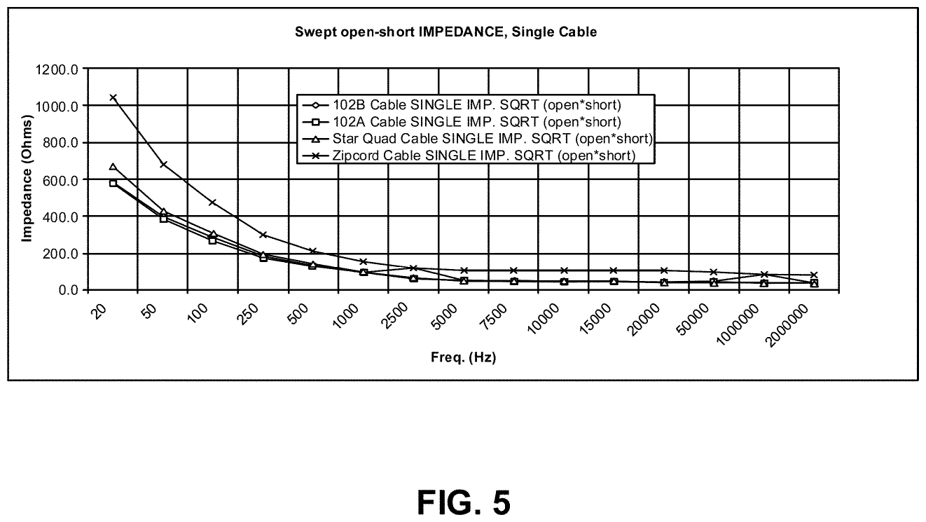

FIG. 5 is a graph of swept impedance vs. frequency of a high frequency cable (e.g., high frequency cable 102A), a low frequency cable (e.g., low frequency cable 102B), a four conductor speaker cable (e.g., a star quad cable), and a two conductor speaker cable (e.g., a zipcord cable). For example, the cables illustrated in FIG. 2 can be at least one of the high frequency cable and/or the low frequency cable tested across the audio band, resulting in the measurements shown in FIG. 5 and listed in table 4 below:

TABLE 4
Swept Open-Short Impedance vs. Frequency

| | | | Star Quad | |
|---|---|---|---|---|
| | 102B Cable | 102A Cable | Cable | Zipcord Cable |
| Frequency | Impedance | Impedance | Impedance | Impedance |
| (Hz) | (Ohms) | (Ohms) | (Ohms) | (Ohms) |
| 20 | 589.5 | 578.6 | 669.9 | 1053.9 |
| 50 | 396.4 | 373.7 | 425.8 | 681.4 |
| 100 | 288 | 264.3 | 304.1 | 483 |
| 250 | 185.1 | 170.1 | 192.7 | 304 |
| 500 | 131.6 | 121 | 136.5 | 217.9 |
| 1000 | 94.2 | 86.1 | 97 | 160.2 |
| 2500 | 63.3 | 56.5 | 64.8 | 120.6 |
| 5000 | 51.5 | 44 | 50.1 | 110.1 |
| 7500 | 48.1 | 40 | 47.6 | 107.6 |
| 10000 | 46.7 | 38.2 | 45.9 | 106.7 |
| 15000 | 45.6 | 36.8 | 44.5 | 157.2 |
| 20000 | 45.2 | 36.2 | 43.8 | 105.4 |
| 50000 | 44.6 | 37.3 | 42.2 | 102.1 |
| 1000000 | 41.9 | 33.5 | 38.7 | 89.4 |
| 2000000 | 41.7 | 33.2 | 38.1 | 88.4 |

As described herein, a change of impedance can exists across the frequency spectrum between the two cables. As shown, utilization of the high frequency cable 102A and/or the low frequency cable 102B can decrease the swept impedance of the bi-wire audio system across the audio band in relation to both the swept impedance of the zipcord cable, and the swept impedance of the star quad cable. Additionally, FIG. 5 also illustrates that the peak and/or high value for impedance across the audio band is lower, in relation to both zipcord cable, and the star quad cable, in both the high frequency cable 102A and the low frequency cable 102B.

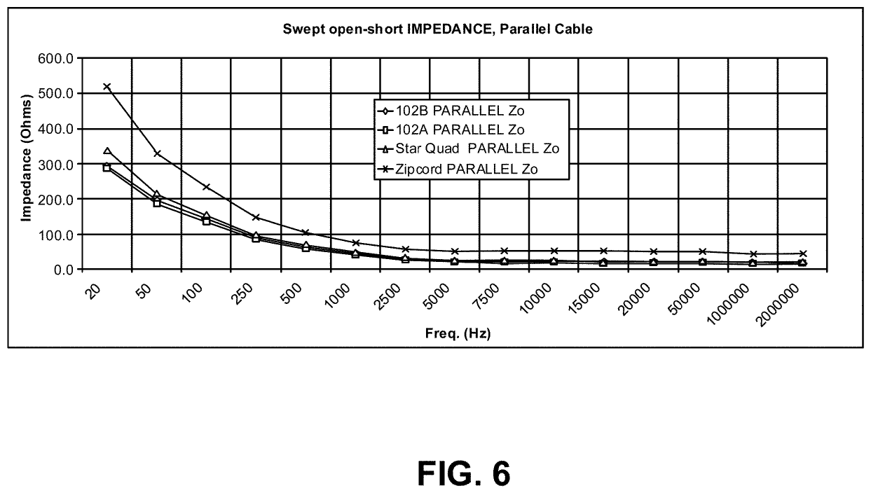

FIG. 6 is a graph of swept impedance vs. frequency of a first high frequency cable (e.g., high frequency cable 102A) and a second high frequency cable in parallel to one another, a first low frequency cable (e.g., low frequency cable 102B) and a second low frequency cable in parallel to one another, a first star quad cable and a second star quad cable in parallel to one another, and a first zipcord cable and a second zipcord cable in parallel to one another, resulting in the measurement illustrated in FIG. 6, and listed in table 5 below:

TABLE 5
Swept Open-Short Impedance vs. Frequency

| | | | Star Quad | |
|---|---|---|---|---|
| | 102B cables | 102A cables | Cables | Zipcord cables |
| Frequency | Impedance | Impedance | Impedance | Impedance |
| (HZ) | (Ohms) | (Ohms) | (Ohms) | (Ohms) |
| 20 | 294.3 | 285.3 | 339.1 | 519.8 |
| 50 | 198.6 | 186.8 | 216.3 | 331 |
| 100 | 143.6 | 133.8 | 153.4 | 235.4 |
| 250 | 92 | 85.2 | 97.4 | 149.3 |
| 500 | 65.5 | 60.3 | 69.1 | 106.7 |
| 1000 | 46.9 | 43.2 | 49.3 | 78.7 |
| 2500 | 31.7 | 28.5 | 32.9 | 59.9 |
| 5000 | 26.1 | 22.5 | 26.4 | 55 |
| 7500 | 24.4 | 20.7 | 24.5 | 53.8 |
| 10000 | 23.8 | 19.8 | 23.6 | 53.2 |
| 15000 | 23.2 | 19.2 | 22.9 | 52.5 |
| 20000 | 23.1 | 19 | 22.7 | 51.9 |
| 50000 | 22.9 | 18.6 | 21.9 | 51.8 |
| 1000000 | 21.6 | 17.7 | 20.2 | 45.2 |
| 2000000 | 21.5 | 17.6 | 19.9 | 44.9 |

As shown, in FIG. 6, utilization of a parallel configuration, similar to that shown in FIG. 4, for the first high frequency cable 102A and the second high frequency cable 102A, the first low frequency cable 102B and the second low frequency cable 102B, can further decrease by almost in half, in relation to the results illustrated in FIG. 5, the swept impedance of the bi-wire audio system across the audio ban. Additionally, FIG. 6 also illustrates that the peak and/or high value for impedance across the audio band is lower, in relation to both the high value for impedance in the parallel zipcord cable configuration, and the high value for impedance in the parallel star quad cable configuration, in both the parallel high frequency cable configuration and the parallel low frequency cable configuration.

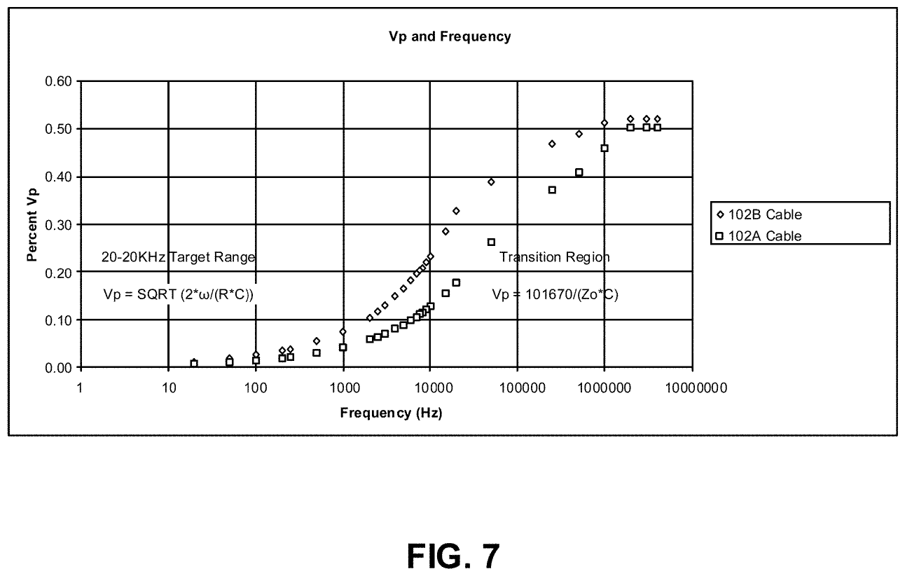

FIG. 7 is a graph of propagation velocity vs. frequency for the high frequency cable 102A and the low frequency cable 102B. As described herein, the high frequency cable 102A and the low frequency cable 102B can have similar propagation velocities at frequencies within the low frequency range. Additionally, the high frequency cable 102A can have lower propagation velocities at frequencies within the high frequency range.

As shown, utilizing the high frequency cable 102A for frequencies within the high frequency range can have a lower propagation velocity in relation to the propagation velocities of the low frequency cable 102B. Additionally, the high frequency cable 102A can also have a lower and/or delayed propagation velocity linearity. For example, the graph illustrated in FIG. 7 shows that a linear increase in the propagation velocities for the high frequency cable 102A occurs at a frequency that is higher than the linear increase in the propagation velocities for the low frequency cable 102B. Additionally, the peak propagation velocity, within the high frequency range, for the high frequency cable 102A is lower than the peak propagation velocity, within the high frequency range, for the low frequency cable 102B.

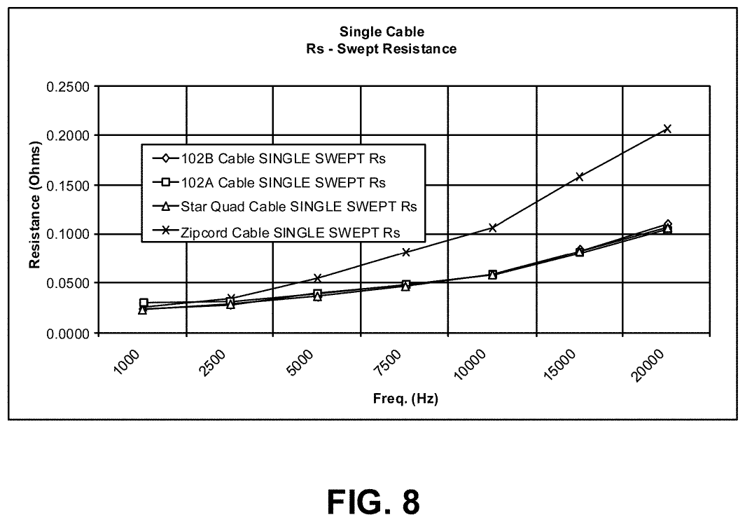

FIG. 8 is a graph of swept resistance vs. frequency of a high frequency cable (e.g., high frequency cable 102A), a low frequency cable (e.g., low frequency cable 102B), a star quad cable, and a zipcord cable. For example, the cables illustrated in FIG. 2 can be at least one of the high frequency cable and/or the low frequency cable tested across the audio band, resulting in the measurements shown in FIG. 8 and listed in table 6 below:

TABLE 6
Swept Resistance vs. Frequency

| | | | Star Quad | |
|---|---|---|---|---|
| | 102B Cable | 102A cable | Cable | Zipcord cable |
| Frequency | Resistance | Resistance | Resistance | Resistance |
| (HZ) | (Ohms) | (Ohms) | (Ohms) | (Ohms) |
| 1000 | 0.02423 | 0.0296 | 0.0264 | 0.0242 |
| 2500 | 0.0273 | 0.0318 | 0.0293 | 0.0342 |
| 5000 | 0.0362 | 0.0386 | 0.03708 | 0.0569 |
| 7500 | 0.04733 | 0.0477 | 0.04719 | 0.0814 |
| 10000 | 0.05946 | 0.0581 | 0.0583 | 0.1067 |
| 15000 | 0.08496 | 0.0805 | 0.0819 | 0.1587 |
| 20000 | 0.11115 | 0.104 | 0.1059 | 0.2073 |

Similar to the change in impedance for the audio system along the radio band, a change in resistance can also exists across the radio band for cables. As shown, utilization of the high frequency cable 102A and/or the low frequency cable 102B can limit the swept resistance of the bi-wire audio system across the audio band in relation to both the swept resistance of the typical zipcord cable, and the swept resistance of the star quad cable. Additionally, FIG. 8 also illustrates that the peak and/or high value for resistance across the audio band is lower, in relation to both the zipcord cable, and the star quad cable, in both the high frequency cable 102A and the low frequency cable 102B.

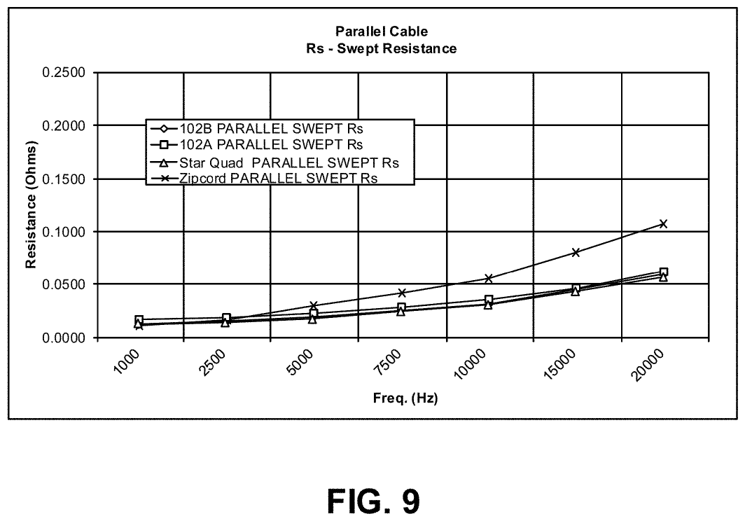

FIG. 9 is a graph of swept resistance vs. frequency of a first high frequency cable (e.g., high frequency cable 102A) and a second high frequency cable in parallel to one another, a first low frequency cable (e.g., low frequency cable 102B) and a second low frequency cable in parallel to one another, a first star quad cable and a second star quad cable in parallel to one another, and a first zipcord cable and a second zipcord cable in parallel to one another. The cables illustrated in FIG. 2 can be at least one of the high frequency cable and/or the low frequency cable tested across the audio band, resulting in the measurements shown in FIG. 8 and listed in table 7 below:

TABLE 7
Swept Resistance vs. Frequency

| | | | Star Quad | |
|---|---|---|---|---|
| | 102B Cables | 102A cables | Cable | Zipcord Cables |
| Frequency | Resistance | Resistance | Resistance | Resistance |
| (HZ) | (Ohms) | (Ohms) | (Ohms) | (Ohms) |
| 1000 | 0.0124 | 0.0149 | 0.0139 | 0.0124 |
| 2500 | 0.0141 | 0.0162 | 0.0154 | 0.0179 |
| 5000 | 0.019 | 0.0202 | 0.0198 | 0.03 |
| 7500 | 0.0251 | 0.0256 | 0.0255 | 0.0431 |
| 10000 | 0.0316 | 0.0315 | 0.0316 | 0.0562 |
| 15000 | 0.0454 | 0.0442 | 0.0446 | 0.082 |
| 20000 | 0.0596 | 0.0574 | 0.0578 | 0.107 |

As shown, in FIG. 9, utilization of a parallel configuration, similar to that shown in FIG. 4, for the first high frequency cable 102A and the second high frequency cable 102A, the first low frequency cable 102B and the second low frequency cable 102B, can further decrease by almost in half, in relation to the results illustrated in FIG. 8, the swept resistance of the bi-wire audio system across the audio ban. Additionally, FIG. 9 also illustrates that the peak and/or high value for resistance across the audio band is lower, in relation to both the high value for resistance of the parallel zipcord cable configuration, and the high value for resistance of the parallel star quad cable configuration, in both the parallel high frequency cable configuration and the parallel low frequency cable configuration.

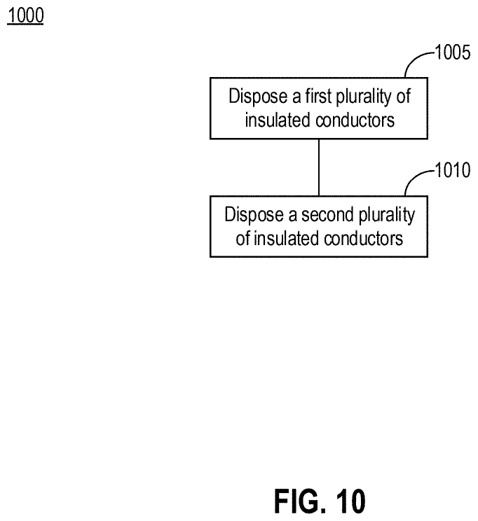

FIG. 10 is a diagram of a process 1000 of manufacturing a bi-wire audio system and/or cable. The bi-wire audio system can include at least one cable. For example, the bi-wire audio system can include at least one of the cable 102A, the cable 102B and/or the cable 320. In ACT 1005, a first plurality of insulated conductors can be disposed. The first plurality of insulated conductors can be disposed within a first cable. For example, the first pair of insulated conductors can be disposed within the cable 102A. The first pair of insulated conductors can be disposed within the cable 102A by at least one of placing, positioning, moving and/or locating the first pair of insulated conductors within the cable 102A. Each of the first plurality of insulated conductors can have a first diameter. The first cable can be connected to a high frequency input of a speaker. For example, the first cable can be the high frequency cable 102A and the first cable can be connected to the high frequency input of the speaker 104.

In ACT 1010, a second plurality of insulated conductors can be disposed. The second plurality of insulated conductors can be disposed within a second cable. For example, the second pair of insulated conductors can be disposed within the cable 102B. The second plurality of insulated conductors can be disposed within the cable 102B by at least one of placing, positioning, moving and/or locating the second plurality of insulated conductors within the cable 102B. Each of the second plurality of insulated conductors can have a second diameter. The second cable can be connected to a low frequency input of a speaker. For example, the second cable can be the low frequency cable 102B and the second cable can be connected to the low frequency input of the speaker 104. The second diameter of each of the second plurality of insulated conductors can be larger than the first diameter of each conductor of the first plurality of insulated conductors

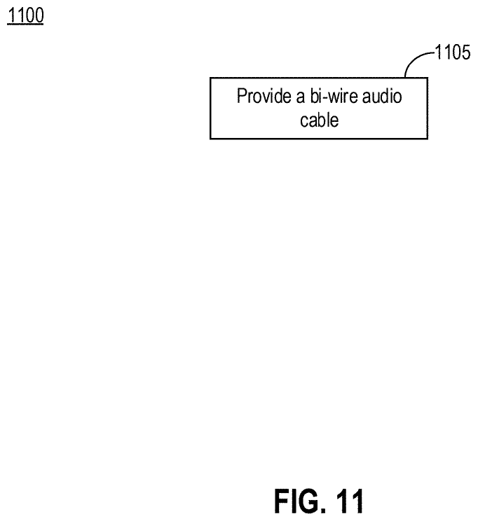

FIG. 11 is a block diagram of a process 1100 of providing a bi-wire audio system and/or cable. In ACT 1105, a bi-wire audio system can be provided. The bi-wire audio system can be provided to at least one of a music studio, a production center, a theater, a music venue, and/or a concert. For example, the bi-wire audio system can be placed, located, positioned, revealed or otherwise discovered at a music venue. The bi-wire audio system can be provided upon the purchasing of the bi-wire audio system. The bi-wire audio system can include at least one first cable (e.g. the high frequency cable 102A). The first cable can have a first plurality of insulated conductors. Each conductor can have a first diameter. The first cable can be connected to a high frequency input of a speaker. The bi-wire audio system can also include a second cable (e.g., the low frequency cable 102B). The second cable can have a second plurality of insulated conductors. Each conductor can have a second diameter. The second cable can be connected to a low frequency input of the speaker. The second diameter of each conductor of the second plurality of insulated conductors can be larger than the first diameter of each conductor of the first plurality of insulated conductors.

Accordingly, the cables and manufacturing techniques described herein provide low capacitance, low inductance cables with different resistances for normalization or flattening of propagation velocity across the audio band when used in a bi-wire system, with round cross-sections for durability and improved common-mode EMI rejection. Capacitance in each cable is reduced via separation of the average positions of conductors in legs carrying single-polarity signals, while inductance is reduced due to magnetic field cancellations from both close spacing and geometry of conductors within each leg and close spacing and geometries of the legs in each cable. The cable can be used for speakers, instruments, microphones, or other signals, and can include both the braid of braided subunits illustrated in FIG. 2C or a single braided subunit.

Although primarily discussed in connection with bi-wire systems with a single amplifier, the cable system discussed herein can also be used with bi-amp systems with a separate amplifier for each cable (e.g. one amplifier and cable connected to a low frequency driver, and a second amplifier and cable connected to a high frequency driver).

The above description in conjunction with the above-reference drawings sets forth a variety of embodiments for exemplary purposes, which are in no way intended to limit the scope of the described methods or systems. Those having skill in the relevant art can modify the described methods and systems in various ways without departing from the broadest scope of the described methods and systems. Thus, the scope of the methods and systems described herein should not be limited by any of the exemplary embodiments and should be defined in accordance with the accompanying claims and their equivalents.

What is claimed is:

1. A bi-wire audio system, comprising:
a first cable having a first plurality of insulated conductors, each conductor having a first diameter, configured for connection to a high frequency input of a speaker; and
a second cable having a second plurality of insulated conductors, each conductor having a second diameter, configured for connection to a low frequency input of the speaker;
wherein the second diameter of each conductor of the second plurality of insulated conductors is larger than the first diameter of each conductor of the first plurality of insulated conductors.

2. The bi-wire audio system of claim 1, comprising:
the low frequency input of the speaker including a frequency range between at least 0 hertz and 300 hertz; and
the first cable and the second cable both having a similar propagation velocity of a signal at a frequency, wherein the frequency is within the frequency range of the low frequency input.

3. The bi-wire audio system of claim 1, comprising:
the first plurality of insulated conductors including:
a first insulated conductor disposed, in parallel to a second insulated conductor of the first plurality of insulated conductors, within the first cable; and
the first insulated conductor, and the second insulated conductor both individually insulated; and
the second plurality of insulated conductors including:
a first insulated conductor disposed, in parallel to a second insulated conductor of the second plurality of insulated conductors, within the second cable; and
the first insulated conductor, and the second insulated conductor both individually insulated.

4. The bi-wire audio system of claim 1, comprising:
the first cable having a resistance value based on a resistance value of each insulated conductor of the first plurality of insulated conductors, and the first cable having a capacitance value; and
the second cable having a resistance value based on a resistance value of each insulated conductor of the second plurality of insulated conductors, and the second cable having a capacitance value;
wherein the resistance value of each insulated conductor of the first plurality of insulated conductors is larger than the resistance value of each insulated conductor of the second plurality of insulated conductors;
wherein the capacitance value of the first cable is higher than the capacitance value of the second cable.

5. The bi-wire audio system of claim 1, comprising:
the first cable having a propagation velocity of a signal in the first cable at a first frequency within the high frequency input; and
the second cable having a propagation velocity of a signal in the second cable at the first frequency within the high frequency input;
wherein the propagation velocity of the signal in the first cable is less than the propagation velocity of the signal in the second cable.

6. The bi-wire audio system of claim 1, comprising:
a third cable having a third plurality of insulated conductors, each conductor having the first diameter, configured for connection to the high frequency input of the speaker; and
a fourth cable having a fourth plurality of insulated conductors, each conductor having the second diameter, configured for connection to the low frequency input of the speaker;
the first cable and the third cable configured to be placed in parallel to one another;
the second cable and the fourth cable configured to be placed in parallel to one another; and
the first cable and the third cable configured to be placed in parallel to the second cable and the fourth cable.

7. The bi-wire audio system of claim 1, comprising:
the first cable, including:
a first insulated conductor of the first plurality of insulated conductors of the first cable placed in parallel to a second insulated conductor of the first plurality of insulated conductors of the first cable;
the first insulated conductor of the first plurality of insulated conductors configured to provide a signal having a first polarity, and the second insulated conductor of the first plurality of insulated conductors configured to provide a signal having a second polarity; and
the second cable, including:
a first insulated conductor of the second plurality of insulated conductors placed in parallel to a second insulated conductor of the second plurality of insulated conductors; and
the first insulated conductor of the second plurality of insulated conductors configured to provide a signal having the first polarity, and the second insulated conductor of the second plurality of insulated conductors configured to provide a signal having the second polarity;
wherein the first polarity and the second polarity are different.

8. The bi-wire audio system of claim 1, comprising:
the first cable, including:
a first pair of insulated conductors of the first plurality of insulated conductors placed in parallel to a second pair of insulated conductors of the first plurality of insulated conductors;
the first pair of insulated conductors of the first plurality of insulated conductors configured to provide a signal having a first polarity, and the second pair of insulated conductors of the first plurality of insulated conductors configured to provide a signal having a second polarity; and
the second cable, including:
a first pair of insulated conductors of the second plurality of insulated conductors placed in parallel to a second pair of insulated conductors of the second plurality of insulated conductors; and
the first pair of insulated conductors of the second plurality of insulated conductors configured to provide a signal having the first polarity, and the second pair of insulated conductors of the first plurality of insulated conductors configured to provide a signal having the second polarity;
wherein the first polarity and the second polarity are different.

9. The bi-wire audio system of claim 1, comprising:
the first cable, including:
a first pair of insulated conductors of the first plurality of insulated conductors placed in parallel to a second pair of insulated conductors of the first plurality of insulated conductors; and
the second cable, including:
a first pair of insulated conductors of the second plurality of insulated conductors placed in parallel to a second pair of insulated conductors of the second plurality of insulated conductors;
wherein both the first pair of insulated conductors of the first plurality of insulated conductors and the second pair of insulated conductors of the first plurality of insulated conductors are placed in parallel to both the first pair of insulated conductors of the second plurality of insulated conductors and the second pair of insulated conductors of the second plurality of insulated conductors.

10. The bi-wire audio system of claim 1, comprising:
the first cable, including:
a first set of insulated conductors of the first plurality of insulated conductors;
the first set of insulated conductors of the first plurality of insulated conductors including a plurality of subsets of insulated conductors; and
a first subset of the plurality of subsets of the first set of insulated conductors of the first plurality of insulated conductors including a first number of insulated conductors; and
the second cable, including:
a first set of insulated conductors of the second plurality of insulated conductors;
the first set of insulated conductors of the second plurality of insulated conductors including a plurality of subsets of insulated conductors; and
a first subset of the plurality of subsets of the first set of insulated conductors of the second plurality of insulated conductors including a second number of insulated conductors;
wherein the first number of insulated conductors and the second number of insulated conductors are different.

11. A system, comprising:
a first plurality of insulated conductors, each conductor having a first diameter, configured for connection to a high frequency input of a speaker; and
a second plurality of insulated conductors, each conductor having a second diameter, configured for connection to a low frequency input of the speaker;
wherein the second diameter of each conductor of the second plurality of insulated conductors is larger than the first diameter of each conductor of the first plurality of insulated conductors.

12. The system of claim 11, comprising:
the low frequency input of the speaker including a frequency range between at least 0 hertz and 300 hertz; and
the first plurality of insulated conductors and the second plurality of insulated conductors both having a similar propagation velocity of a signal at a frequency, wherein the frequency is within the frequency range of the low frequency input.

13. The system of claim 11, comprising:
the first plurality of insulated conductors having a resistance value; and
the second plurality of insulated conductors having a resistance value;
wherein the resistance value of the first plurality of insulated conductors is larger than the resistance value of the second plurality of insulated conductors.

14. The system of claim 11, comprising:
the first plurality of insulated conductors having a propagation velocity of a signal in the first plurality of insulated conductors at a first frequency within the high frequency input; and
the second plurality of insulated conductors having a propagation velocity of a signal in the second plurality of insulated conductors at the first frequency within the high frequency input;
wherein the propagation velocity of the signal in the first plurality of insulated conductors is less than the propagation velocity of the signal in the second plurality of insulated conductors.

15. The system of claim 11, comprising:
a third plurality of insulated conductors, each conductor having the first diameter, configured for connection to the high frequency input of the speaker; and
a fourth plurality of insulated conductors, each conductor having the second diameter, configured for connection to the low frequency input of the speaker; and
the first plurality of insulated conductors and the third plurality of insulated conductors configured to be placed in parallel to the second plurality of insulated conductors and the fourth plurality of insulated conductors.

16. The system of claim 11, comprising:
the first plurality of insulated conductors, including:
a first insulated conductor placed in parallel to a second insulated conductor;
the first insulated conductor configured to provide a signal having a first polarity;
the second insulated conductor configured to provide a signal having a second polarity; and
the second plurality of insulated conductors, including:
a first insulated conductor placed in parallel to a second insulated conductor; and
the first insulated conductor configured to provide a signal having the first polarity, and the second insulated conductor configured to provide a signal having the second polarity;
wherein the first polarity and the second polarity are different.

17. The system of claim 11, comprising:
the first plurality of insulated conductors, including:
a first pair of insulated conductors placed in parallel to a second pair of insulated conductors; and
the second plurality of insulated conductors, including:
a first pair of insulated conductors placed in parallel to a second pair of insulated conductors;
wherein both the first pair of insulated conductors of the first plurality of insulated conductors and the second pair of insulated conductors of the first plurality of insulated conductors are placed in parallel to both the first pair of insulated conductors of the second plurality of insulated conductors and the second pair of insulated conductors of the second plurality of insulated conductors.

18. A method of manufacturing a bi-wire audio cable, comprising:
disposing, within a first cable, a first plurality of insulated conductors, each conductor having a first diameter, the first cable configured for connection to a high frequency input of a speaker; and
disposing, within a second cable, a second plurality of insulated conductors, each conductor having a second diameter, the second cable configured for connection to a low frequency input of the speaker;
wherein the second diameter of each conductor of the second plurality of insulated conductors is larger than the first diameter of each conductor of the first plurality of insulated conductors.

19. The method of claim 18, comprising:
disposing, within a third cable, a third plurality of insulated conductors, each conductor having the first diameter, the third cable configured for connection to the high frequency input of the speaker; and
disposing, within a fourth cable, a fourth plurality of insulated conductors, each conductor having the second diameter, the fourth cable configured for connection to the low frequency input of the speaker; and
the first plurality of insulated conductors and the third plurality of insulated conductors configured to be placed in parallel to the second plurality of insulated conductors and the fourth plurality of insulated conductors.

20. The method of claim 18, comprising:
disposing a first insulated conductor of the first plurality of insulated conductors in parallel to a second insulated conductor of the first plurality of insulated conductors; and
disposing a first insulated conductor of the second plurality of insulated conductors in parallel to a second insulated conductor of the second plurality of insulated conductors;
the first insulated conductor of the first plurality of insulated conductors configured to provide a signal having a first polarity and the second insulated conductor of the first plurality of insulated conductors configured to provide a signal having a second polarity; and
the first insulated conductor of the second plurality of insulated conductors configured to provide a signal having the first polarity, and the second insulated conductor of the second plurality of insulated conductors configured to provide a signal having the second polarity;
wherein the first polarity and the second polarity are different.
